(19) United States
(12) Patent Application Publication
(10) Pub. No.: US 2012/0079366 A1
(43) Pub. Date: Mar. 29, 2012

(54) MEASUREMENT OF CONTENT PLACEMENT EFFECTIVENESS OVER WEB PAGES AND LIKE MEDIA

(76) Inventor: David COHEN, Tel-Aviv (IL)

(21) Appl. No.: 13/244,963

(22) Filed: Sep. 26, 2011

Related U.S. Application Data
(60) Provisional application No. 61/386,610, filed on Sep. 27, 2010.

(51) Int. Cl. G06F 17/00

(52) U.S. Cl. 715/234

(57) ABSTRACT

A system for measuring on-screen content item effectiveness, the content item being located at a predetermined location in a content page, the content page being for display through a user client defining a currently visible area such that at any given time only part of the content page is within said currently visible area, the user client allowing a user to move through the content page to change the part of the content page within the currently visible area. The system comprises a movement detection unit within the user client for detection of movement of the content page within the user client, and a parameter constructor, within the user client and associated with the movement detection unit for inferring whether the content item is within the currently visible area therewith to locally generate a cumulative parameter to indicate the time the content item is visible on a user screen.

### RELATED APPLICATIONS

This application claims the benefit of priority under 35 USC 119(e) of U.S. Provisional Patent Application No. 61/386,610 filed Sep. 27, 2010, the contents of which are incorporated herein by reference in their entirety.

### FIELD AND BACKGROUND OF THE INVENTION

The present invention relates to a system and method for measuring of effectiveness of content placement over the Internet, in particular advertising content and, more particularly, but not exclusively to a method and apparatus for measuring the effectiveness of advertising placement over web pages and like media.

It is generally a concern of advertisers to ensure that advertising content reaches a target audience and receives attention. Sales depend on the attention paid by the target audience to the advertising content. There are numerous systems for attempting to direct content at target audiences, and the issue certainly predates the Internet. From the very earliest days of computing, packages allowed names and addresses to be labeled so that mailshots could be directed at persons marked with particular labels. Advertising in journals is often targeted at typical profiles of readers of the particular journal. Furthermore, advertising rates for the journals are often variable according to the location in the journal so that locations likely to gain more attention are priced higher.

Advertising on web sites is very similar to advertising in journals, in that placement of advertising content can easily be based on an expected reader profile, and location within the website and on the webpage can be selected and priced according to the expected amount of attention.

At the moment however, journals and web pages have in common that the difference in the amount of attention an advertisement receives based on its location on the page is something that can only be estimated. It is not possible to know which part of the page can be expected to receive more attention. It is not possible to know which part of the page in fact received more attention and it is certainly not possible to charge for the advertising based on attention actually received. One reason for this is that a web page is downloaded as a whole from a webserver in a single operation, and then the browser lays out the page and allows the user to scroll through the page etc without further reference to the server. The server thus simply does not know which part of the page the user is looking at.

It is of course possible on the Internet to pay for advertising based on the number of clicks received but there is no way to determine to what extent the advertisement has been seen.

There has thus been proposed a system that estimates the part of a current content page that is currently visible on a user screen. A movement detection unit detects movement of the content page within the user's browser, and an estimator infers whether a particular content item of interest is within the currently visible area. The movement detection unit in one version detects operating system directives to find out whether the user is scrolling etc through the page. Alternatively an identifiable point is placed on the content item and continual measurement is made between identifiable point in the content and a point in the currently visible area. The raw data is then sent to an external server which reconstructs what is happening on the screen. From this it may be determined where the banner was located and when and how long it was the focus of interest. The system is useful for providing statistical data about the effectiveness of advertisement placement within web pages.

However there is a problem with the large quantity of data that needs to be sent out. Also particular computer systems may enforce formatting on the packets being sent out that renders them difficult to read by the receiving system. Since the data is cumulative in nature, the loss or misreading of any packet makes any following data difficult to interpret.

Furthermore the large quantity of raw data, a particular advertising campaign may reach thousands or millions of end users, means that real time processing of the information is not possible. Results may only be available in hours or even days.

The following embodiments address these issues.

### SUMMARY OF THE INVENTION

According to one aspect of the present invention there is provided a system for measuring on-screen content item effectiveness, the content item being located at a predetermined location in a content page, the content page being for display through a user client defining a currently visible area such that at any given time only part of the content page is within said currently visible area, the user client allowing a user to move through the content page to change the part of the content page within the currently visible area, the system comprising:

a movement detection unit within the user client for detection of movement of the content page within the user client, and

a parameter constructor, within the user client and associated with the movement detection unit for inferring whether the content item is within the currently visible area therewith to locally generate a cumulative parameter to indicate the time the content item is visible on a user screen.

In an embodiment, said parameter builder builds strings of each one of a plurality of processed parameters.

In an embodiment, said plurality of processed parameters comprise a percentage of time that a content item is within said currently visible area.

In an embodiment, said plurality of processed parameters comprise a time stamp for when a webpage containing the content item was entered combined with an accumulation of how long the page has been loaded on the page.

In an embodiment, said plurality of processed parameters comprise an accumulated in focus time and an accumulated out of focus time.

In an embodiment, said plurality of processed parameters comprises an accumulated idle time.

In an embodiment, said plurality of processed parameters comprises accumulated mouse click coordinates.

In an embodiment, said movement detection unit continually tracks a cursor in order to detect patterns indicative of click fraud or remote operation of a computer, or website artificial manufacture of a click.

An embodiment may be configured to send said data from said user upon a predetermined event. The predetermined event comprises one member of the group consisting of exit of a webpage and exit of a browser.

The data may comprise an IP address of the end user.

The system may conveniently obtain the IP address from an initial user request for a respective web page.

In an embodiment, said data further comprises one member of the group consisting of:

a name of said content item; a setting for communicating with cookies, a referrer, a browser language, a user language, a Cpu class, a screen width and screen height, and a browser window height and width.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing an exemplary web-browser view of a web page carrying both basic content and advertising content;

FIG. 2 is a simplified diagram showing a system according to an embodiment of the present invention for recognizing movement, that is page adjustment within the browser and using the recognized movement to estimate whether the advertising content is currently within the view;

FIG. 3 is a more detailed diagram of the system of FIG. 2 and in particular showing a first variation of obtaining motion estimation according to an embodiment of the present invention;

FIG. 4A is a second, more detailed diagram of the system of FIG. 2 and in particular showing a second variation of obtaining motion estimation according to an embodiment of the present invention.

FIG. 4B illustrates an item of content into which has been embedded an envelope which includes detect, generate and report functionality, in accordance with an embodiment of the present invention;

FIG. 5 is a system diagram illustrating the present embodiments.

### DESCRIPTION OF THE PREFERRED EMBODIMENTS

The present embodiments comprise an apparatus and a method for estimating the amount of attention that has been directed by a user to content located on a web page. A preferred embodiment tracks the movement of the web page within the browser window so that an estimate can be made as to whether advertising content at a particular location on the page is currently visible to the user, or whether actual web content is being read, say whether a student has actually read an article. That is to say the embodiment may track the user's attention over the web page content itself or over incidental content such as advertising content.

One method involves including an identifiable point, a landmark, at a given location on the web page. A user client then measures the distance from say the top of the user window, a fixed screen location, to the identifiable point and reports the measurement. The measurement allows an operator to know what part of the page is visible and he can then determine whether the advertising content is currently visible.

An alternative embodiment simply captures operating system directives and tracks activities such as scrolling. Again the location on the page, and the corresponding exposure of the advertising content, can be estimated.

The extracted data may be superimposed over a grid of the web page to show in graphical form the user-web page interaction.

The raw data from the on-screen movements is combined into strings or accumulations of parameters to form a self-contained data unit, which may then be sent to an external server.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

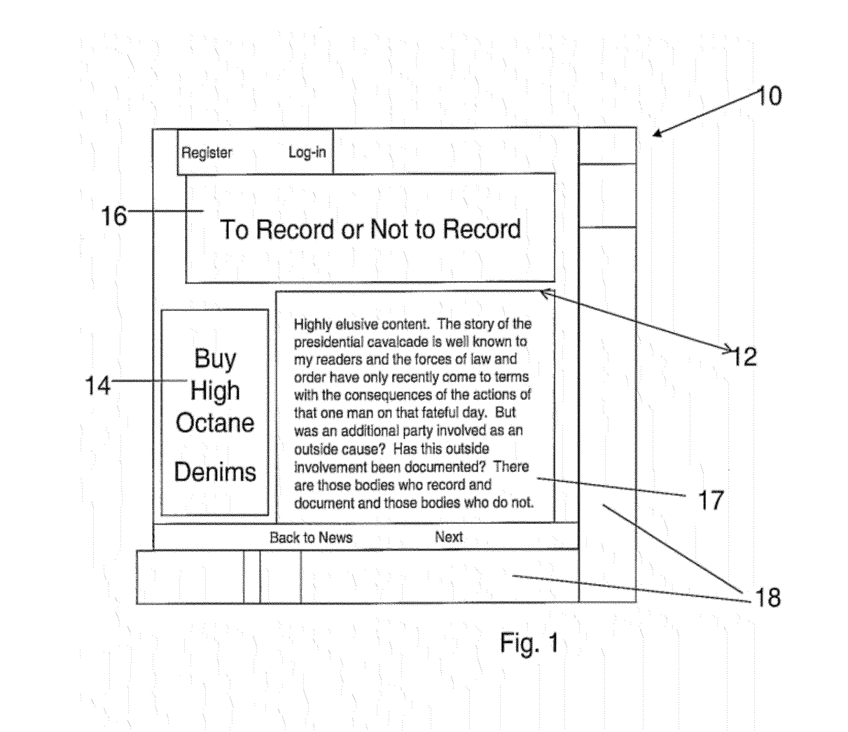

Reference is now made to FIG. 1, which is a simplified diagram illustrating a typical web page view 10 including primary content 12 and advertising content 14. The primary content is divided into two objects, a headline object 16 and a story 17. Scroll bars 18 at the right and lower sides of the view 10 allow the user to navigate through the page.

The advertising content is currently located at a fairly central location on the screen but as soon as the user scrolls down into the article the advertising content 14 may be expected to disappear at the top of the screen. Thus merely knowing whether a user has a web page open does not equate to knowing how much attention is being paid, or could even conceivably be paid, to given advertising content. If the particular web page has multiple content items then it would not be apparent which content item the user is currently viewing.

In the present embodiment the effectiveness of the advertising content item 14 is inferred from the amount of time the advertising content item itself is visible on a user screen, and it will be appreciated that this visible time, hereinafter exposure time, is only a fraction of the time that the web page on which it is located is visible on the user screen.

The advertising content item 14 is situated at a predetermined location in relation to content 12, that is within the current web page, and the web page is a typical web page for display through a user client such as a web browser, as is well known in the art. The browser does not show an entire page but rather defines a currently visible area which is just a fraction of the page, such that at any given time only part of the web page is within the currently visible area. As is well known, the browser allows a user to move through the content page to change the part of the content page within the currently visible area. For the purpose of navigating through the page it is possible to use arrow controls on a key board, or page up or page down commands, or to use a mouse or like interaction device with a cursor. Typically a web browser provides the sliders 18 at the side and base of the screen, as mentioned hereinabove, to allow cursor based navigation.

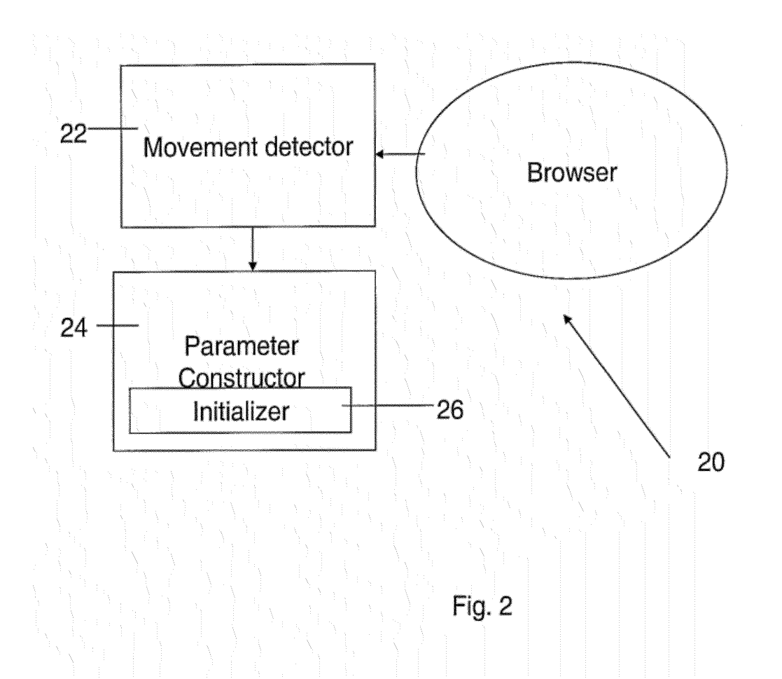

Reference is now made to FIG. 2, which is simplified diagram illustrating apparatus 20 for measuring on-screen content item effectiveness according to a first preferred embodiment of the present invention. In the diagram, a movement detection unit 22 detects movement of the content page within the user client, using for example one of a number of techniques explained below, and a parameter constructor 24, is associated with the movement detection unit. The constructor uses movement information from the movement detector 22 to infer whether the content item 14 is within the currently visible area 10. From that it is able to provide data as to how long individual items of advertising content remain in view, that is the advertisement exposure time, and is thus able to provide advertisers with feedback as to good and bad locations on a website, as will be explained in greater detail below.

The estimator is preferably also associated with an initializer unit 26 for obtaining operating system and screen resolution data of the user initially connecting to a provider of the content page, so that movements on the screen can be related to page size and the like to make the estimates reasonable.

As will be explained below, the movement detector 22 is preferably provided as a layer within the user's browser program. The parameter constructor likewise may be based at the user. Alternatively the movement detector and parameter constructor may be objects loaded with the web page. They may be part of the web page, or part of the banner or objects that are called by the banner.

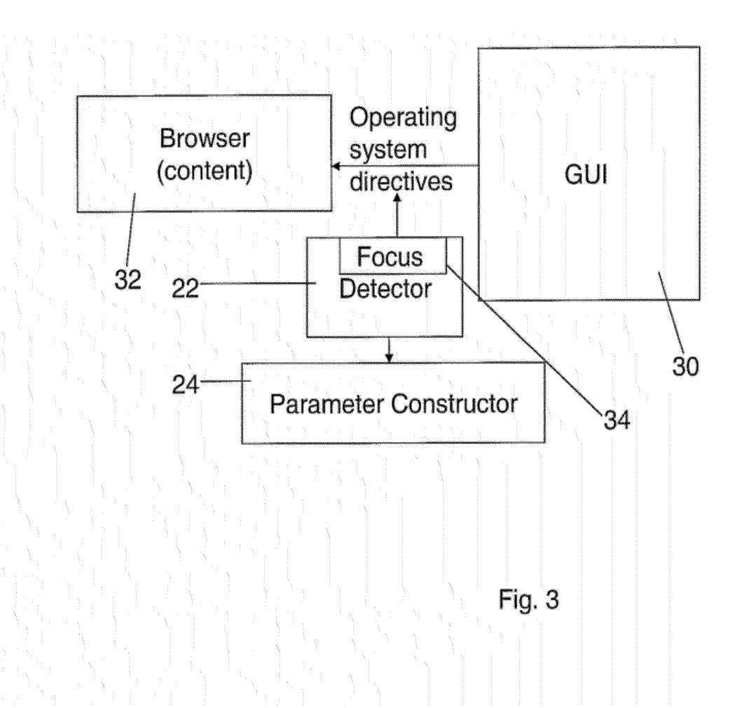

Reference is now made to FIG. 3, which illustrates one possible technique for movement estimation. In FIG. 3 the user interacts with the browser by issuing movement commands through a graphical user interface (GUI) 30. That is user interactions such as mouse clicks and key presses are captured by the GUI and changed into operation system directives which are passed on to the appropriate program, in this case the browser.

The movement detection unit 22 is a layer within the browser 32 as explained. The movement detector intercepts the operating system directives aimed at the browser, which include the movement commands for moving content around the browser. That is to say the movement detector recognizes and extracts operating system directives relating to movement of the content within the browser screen. Such a layer may recognize page up and page down commands, as well as mouse clicks. The layer, through initializer 26, is able to query the screen resolution and is thus able to relate incoming mouse clicks to the browser to determine whether for example the slider has been activated.

Such a layer is preferably fully transparent to the user. It will be appreciated that its operation is of no direct interest to the user, but rather is of interest to advertisers and to parties making advertising space available.

Detector 22 further comprises a focusing unit 34 for identifying operating system activity indicating attention around the content item. In addition to mouse clicks and key presses it is also possible to capture mouse movements from the operating system. A page across which a mouse was being moved is more clearly a center of attention than one on which no mouse movement is being detected. The focus unit uses the captured mouse movements to determine whether the window showing the content item has current focus and/or whether mouse movements etc are near or far from the location of the advertising content 14. That is to say the actual mouse or cursor movements are followed even without mouse clicks.

The focusing unit can be used to determine whether a particular user has paid attention to a particular article or the like that he is supposed to read. For example the focusing unit may indicate whether students have read a particular text that has been set for them. In addition the focusing unit can determine that a particular part of the article received particular attention. Thus it may be apparent that a particular part was especially difficult or especially interesting, information which can be useful when subsequently reviewing the website. In order to obtain such information the web page may be divided into a grid, as will be discussed in greater detail below. The grid may be a uniform grid or the page may be defined based on logical units of the content, as preferred. The system determines which areas of the grid were visible for how long and/or which areas of the grid had high levels of focus when visible. The grid is particularly useful where the analysis required is of the actual content of the web page and not of specific items on the page such as advertisements. The grid can also be used to analyze how long certain areas have been out of view and delays until they return to view, as will be discussed in greater detail below.

Furthermore the operating system directive for printing can be obtained so that the system knows if someone printed the article. Hence it is possible to presume that the article was given attention even though the focusing unit has not detected much focus.

Operation of the focusing unit and its ability to enhance the output of the presently considered system is discussed in greater detail below.

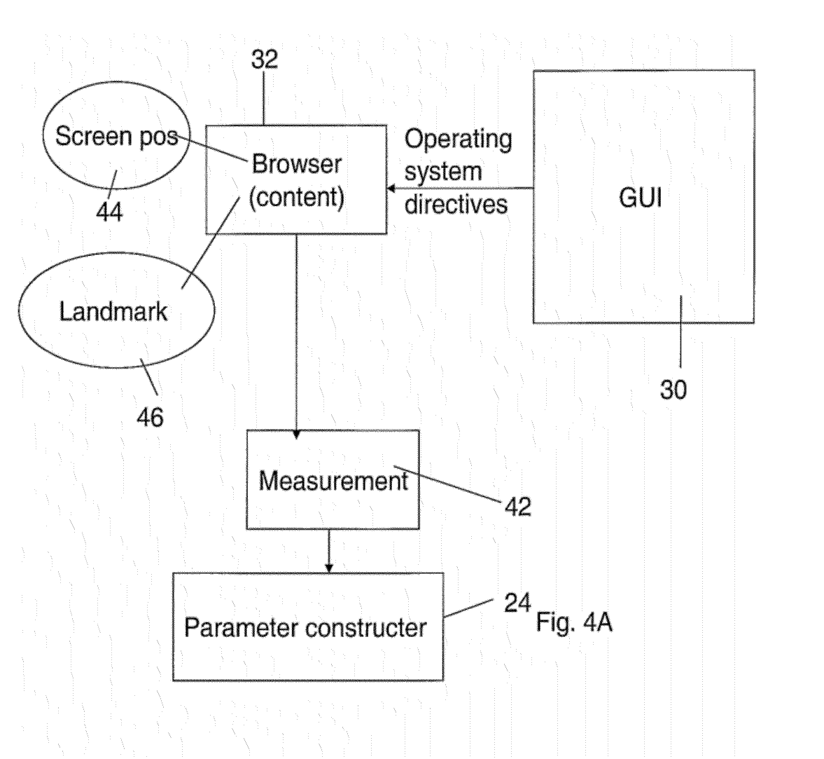

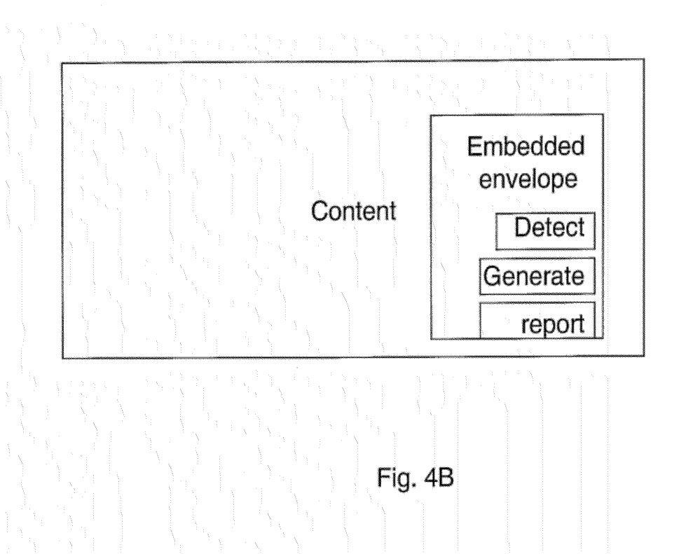

Reference is now made to FIG. 4A, which illustrates a second possible technique for detection of motion of the web page within the browser. In FIG. 4A the motion detector comprises a measurement unit 42 for measuring distance over a web page. The content page itself includes an easily identifiable location somewhere on the page, say a red dot on the right hand margin of the page. The location is referred to hereinafter as a landmark 42. The landmark is chosen to be easy for the measurement unit to detect. Measurement unit 42 continually measures distances from a predefined point on the browser screen-screen position 44, which is a convenient point on the currently visible area, to the landmark, the red dot. The screen position used may be for example the top right hand corner of the browser window. As the web page is scrolled through the browser the distance from the landmark to the top of the view changes, and it is this changing distance which can be used to estimate which part of the web page is currently being viewed.

From the measurement the position of the content in the browser can be determined and the current location of the advertising content can be inferred. The inference may be carried out at the layer itself, or alternatively at a remote server over the Internet, where advertising management is being carried out.

In either of the above techniques, the content page itself may be divided into a grid, each grid square being individually identifiable. The construtor 24 uses the output of the movement detector to determine which grid space best describes the currently visible area. The current grid space is then used in parameter construction, as will be explained in greater detail below. It is particularly advantageous to produce a result in terms of grid squares rather than absolute measurements as this produces a more compact result which can be used directly.

In a further embodiment, objects belonging to the web page are downloaded to the browser with co-ordinates, so that the browser knows where on the web page to place the objects. Thus the system merely needs to know the location of a single point on the web page, say the upper right corner of the window, in order to be able to determine which of the objects are currently in view.

In a further embodiment the system knows the layout of the web page, since the web page as downloaded to the browser includes the coordinates of all content items. The content items may be identified by names, including file names. Thus the system merely checks the coordinates of two opposite corners of the active window and knows what content is currently in view.

As an alternative, only one location needs to be known as well as the screen size and resolution of the user, so that the height and width of the browser is known. If an initial location is known then the system may merely obtain the size of a scroll action. The system may retain a synthetic version of the web page and track movement of the visible area on the synthetic page so that no information of the actual objects from the user is required. The result is a significant saving in the amount of data that needs to be sent, since only movement information needs to be sent and the analysis is done remotely.

In a further embodiment, the system notes the position of the middle line of the visible screen and the time, thus it may determine that the line 10 cm from the top of the screen was the center of the screen for 15 seconds. The system may use the data to follow on a parallel screen.

A unique identifier (UID) is provided. A firewall or organization server does not in general pass on IP addresses so that it is difficult to determine how many separate computers lie behind the firewall. In the present embodiments each separate browser is given a separate unique identifier, not having any relationship to an IP address, and thus the system is able to determine, through a firewall, how many computers are connected.

The embodiment of FIG. 4A may also include focusing unit 34, as discussed above in respect of FIG. 3, to indicate operating system activity around the advertising content.

In an embodiment for measuring on-screen content item effectiveness, say the effectiveness of an advertising banner located on a web page, a movement detection unit as before is provided within the user client for detection of movement of the content page, but the estimator becomes a parameter constructor, is located within the user client and accumulates parameters to infer when, whether and for how long the content item is within the currently visible area therewith. The constructor uses an accumulation of any of the raw data discussed above or below to locally generate a cumulative parameter to indicate the time the content item is visible on a user screen.

The parameter constructor 24 may build strings of various processed parameters.

The processed parameters comprise any of a percentage of time that a content item is within said currently visible area, a time stamp for when a webpage containing the content item was loaded, combined with an accumulation of how long the page has been loaded on the page, an accumulated in focus time, meaning when the web page of interest is the active window on the screen, and an accumulated out of focus time, an accumulated idle time—meaning the time when the computer is idle, irrespective of whether the web page is in focus, and accumulated mouse click coordinates. The determination of idleness can be based on mouse movements, and time limits without movements may be selected as appropriate. The determination of idle time may be determined in relation to time in which the banner is visible.

From the movement that the system counts idle time it may also count waiting time.

The movement detection unit continually tracks a cursor in order to detect patterns. The patterns may indicate click fraud, typically through clicks not related to mouse movements. Alternatively the patterns may indicate remote operation of a computer, typically through operation without a mouse at all, or even artificial manufacturing of a click by the website. The latter may be a variation of click fraud initiated by the website carrying the adverts, or may actually download chargeable content to a user, possibly without his knowledge.

That is to say legitimate clicks are associated with mouse or cursor movements, and lack of the associated mouse movements indicates that something unusual, and possibly illegitimate, is happening. It is possible that a legitimate user may operate with key operations and without a cursor but it is very unlikely, and the chances of large numbers of people doing so in relation to a given site or a given banner in a site is indicative of fraud.

The system may obtain relatively instantaneous indications of fraud or hacking.

It is also possible to determine the time delay between the arrival of the web page and the time at which the click was made. Large numbers of clicks made immediately upon entry to the page can suggest something suspicious, since legitimate clicks come after some time has passed and the user has read the banner.

The actual time between a banner in view event and the click may be sent.

The system may send data from the user to a central location upon a predetermined event.

The predetermined event may comprise for example exit of a webpage or exit of a browser. In the case of click fraud or the like, the actual detection of the fraudulent patterns may provide the event to set off the report. The system may therefore provide a real time indication of fraud or hacking.

The data comprises an IP address of the end user, which may be obtained say from an initial user request for a respective web page. Alternatively the data may comprise a code representing the IP address, the codes being tabulated against the IP address.

The data may further comprise the parameters mentioned above but also a name of the content item or banner, a setting for communicating with cookies, in particular specific cookies, a referrer, that is to say a web page or site that referred the user to the web page of interest, a browser language, a user language, a Cpu class, a screen width and screen height, and a browser window height and width.

The system may determine that only part of the banner etc. is visible or it may decide that if less than a certain percentage of the banner is not visible then the banner itself is regarded as not being visible.

The use of the time stamp allows for the accumulated data to give indications of absolute time, and for example to see patterns in behavior, certain web pages are being read at certain times of the day etc, or to be minimized or put out of focus. Thus indications can be gleaned by advertisers as to best times to advertise.

The data is aggregated at the user so that very little information is sent and the information that is sent can be processed and presented in real time or near real time, since there is relatively little computing for the central server to do.

In the present embodiment, each set of data that is sent is self-contained and therefore independent of any other events of sending of data. Thus any data that is sent and lost has no knock-on effect.

Furthermore, since the data is more compact and more easily recognizable, particular computing systems are less likely to render the data unreadable at the recipient.

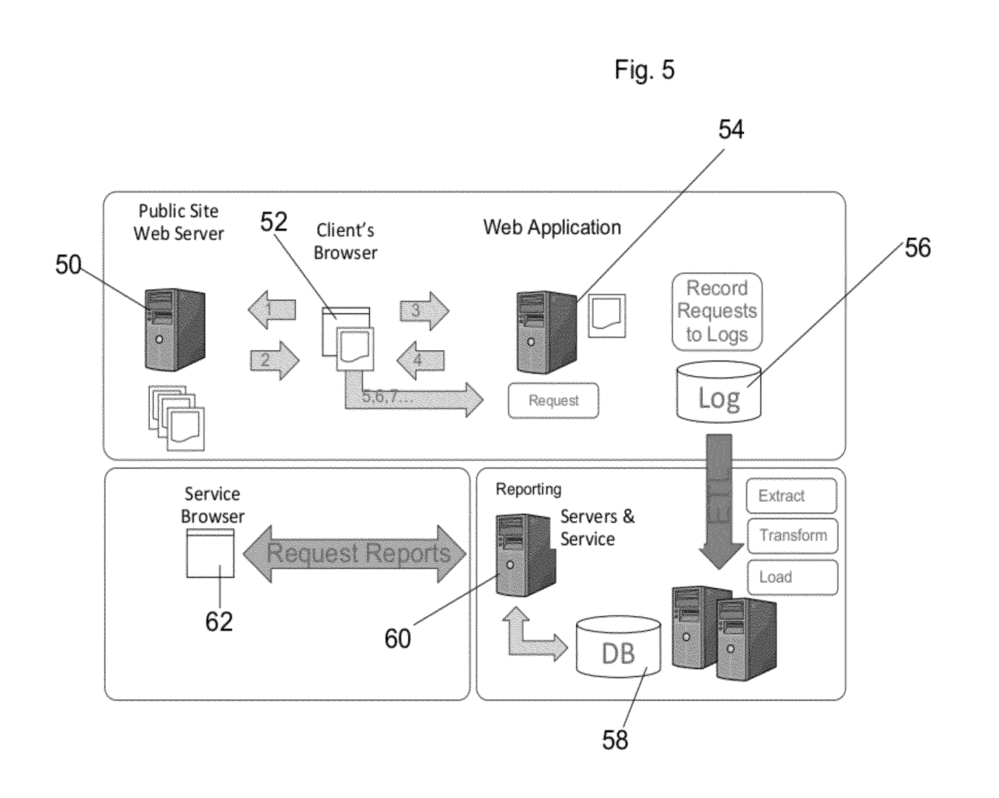

Reference is now made to FIG. 5, which is a simplified diagram illustrating an embodiment of the present invention from a system point of view.

A public web server 50 serves web pages to clients 52. The client's browser makes a web request (arrow 1) for the page to the server, typically by clicking on a link. The server downloads the page, (arrow 2). The page includes an object whose presence is to be monitored, so the object requests the monitor of the present embodiments (arrow 3). A web application server 52 receives the request and provides the monitor (arrow 4). The monitor then provides details, identified by the UID, to the web application server 54. The information received is then logged in log 56 and the provided to database 58 at reporting servers 60. The reporting servers then provide reports on request to service browser 62, typically the entity that owns the objects that are being monitored.

It will be noted that in an alternative embodiment the monitor may be downloaded together with the web page and there is no need for a separate request.

In a further embodiment, the system obtains the screen size, resolution etc. from the client browser. The client downloads a web page of known proportions and merely traces a single marker. The system carries its own version of the page onto which it superimposes the window of the browser and thus knows which part of the page the client currently sees as visible.

In a further embodiment the client may download a monitor on his own initiative to indicate tracking of objects on his screen. The data generated from the monitoring may then be provided to a central system monitor, and then the central system monitor may generate new data based on objects it has not previously known. The database may then provide information as to whether a particular user has or has not seen particular information, or parts of information, including specific banners.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. System for measuring on-screen content item effectiveness, the content item being located at a predetermined location in a content page, the content page being for display through a user client defining a currently visible area such that at any given time only part of the content page is within said currently visible area, the user client allowing a user to move through the content page to change the part of the content page within the currently visible area, the system comprising:
a movement detection unit within the user client for detection of movement of the content page within the user client, and
a parameter constructor, within the user client and associated with the movement detection unit for inferring whether the content item is within the currently visible area therewith to locally generate a cumulative parameter to indicate the time the content item is visible on a user screen.

2. The system of claim 1, wherein said parameter builder builds strings of each one of a plurality of processed parameters.

3. The system of claim 2, wherein said plurality of processed parameters comprise a percentage of time that a content item is within said currently visible area.

4. The system of claim 2, wherein said plurality of processed parameters comprise a time stamp for when a webpage containing the content item was entered combined with an accumulation of how long the page has been loaded on the page.

5. The system of claim 2, wherein said plurality of processed parameters comprise an accumulated in focus time and an accumulated out of focus time.

6. The system of claim 2, wherein said plurality of processed parameters comprises an accumulated idle time.

7. The system of claim 2 wherein said plurality of processed parameters comprises accumulated mouse click coordinates.

8. The system of claim 2, wherein said movement detection unit continually tracks a cursor in order to detect patterns indicative of click fraud or remote operation of a computer, or website artificial manufacture of a click.

9. The system of claim 1, configured to send said data from said user upon a predetermined event.

10. The system of claim 9, wherein said predetermined event comprises one member of the group consisting of exit of a webpage and exit of a browser.

11. The system of claim 9, wherein said data comprises an IP address of the end user.

12. The system of claim 9, configured to obtain said IP address from an initial user request for a respective web page.

13. The system of claim 9, wherein said data further comprises one member of the group consisting of:
a name of said content item; a setting for communicating with cookies, a referrer, a browser language, a user language, a Cpu class, a screen width and screen height, and a browser window height and width.

14. The system of claim 1, further configured with a unique identification unit to provide identifications to individual browsers that are located behind firewalls, so that said individual browsers are identifiable when said firewalls suppress Internet address information.

15. The system of claim 1, wherein said movement detection unit is configured to use a marker on said content page to continually calculate a location that is in the middle of said currently visible area.

16. The system of claim 1, comprising a remote tracking unit for using data sent from said movement detection unit together with client screen resolution and size data to superimpose a browser window over a replica of said content page to determine said currently visible area at said user.
